(19) United States
(12) Patent Application Publication
(10) Pub. No.: US 2007/0244247 A1
(43) Pub. Date: Oct. 18, 2007

(54) AQUEOUS ADHESIVE FOR RUBBER TO METAL BONDING

(76) Inventors: Douglas H. Mowrey, Titusville, PA (US); Thomas Christtans Gaadi, Erie, PA (US)

Correspondence Address: LORD CORPORATION;PATENT & LEGAL SERVICES, 111 LORD DRIVE, CARY, NC, 27512, US

(21) Appl. No.: 11/734,928

(22) Filed: Apr. 13, 2007

Related U.S. Application Data
(60) Provisional application No. 60/791,824, filed on Apr. 13, 2006.

(51) Int. Cl. C08F 283/08

(52) U.S. Cl. 524/508

(57) ABSTRACT

An aqueous adhesive composition that includes (A) a butadiene polymer latex that is prepared by an emulsion polymerization in the presence of a polyvinyl alcohol stabilizer and (B) a phenolic resin, preferably a polyvinyl alcohol stabilized resole.

### CROSS REFERENCE

This application claims the benefit of, and incorporates by reference, U.S. Provisional Patent Application No. 60/791,824 filed Apr. 13, 2006.

### FIELD OF THE INVENTION

The present invention relates to an aqueous butadiene latex, particularly an aqueous butadiene latex that is compatible with an aqueous phenolic resin to form an adhesive. The adhesive of the present invention is particularly useful as a general purpose covercoat adhesive for rubber to metal bonding.

### BACKGROUND OF THE INVENTION

Various techniques are known to emulsion polymerize butadiene polymers to obtain an aqueous latex. For example, according to an English translation, DE-A-33 21 902 relates to an aqueous emulsion polymerization for making chloroprene rubber than involves polymerizing chloroprene, optionally with up to 50 weight percent of a copolymerizable monomer, in the presence of 0.5 to 5 weight percent of a rosin acid derivative and 0.1 to 10 weight percent of a polystyrene sulfonic acid derivative, based on the weight of the total monomers. Copolymers of 95 weight percent chloroprene and 5 weight percent 2,3-dichlorobutadiene are exemplified. The addition of the polystyrene sulfonic acid was shown to reduce the adhesion of the chloroprene rubber to a metal mold.

U.S. Pat. No. 4,054,547 relates to a process for copolymerizing chloroprene and 0.5-10 weight percent (based on total monomers) of at least one styrene sulfonic acid or a water soluble derivative thereof in an aqueous medium to form latex particles. The addition of an ethylenically unsaturated co-monomer to the system is mentioned. 2,3-dichlorobutadiene is listed as a possible co-monomer.

U.S. Pat. No. 4,400,229 relates to an aqueous dispersion of a phenolic resole and a thermoplastic polymeric material or a rubber prepared by dissolving a solid thermoplastics material or a rubber into a liquid phenol; adding a nonionic or anionic surface active agent and/or protective colloid; adjusting the pH of the mixture to above 7; adding aqueous formaldehyde solution or a formaldehyde donor and heating the mixture to form a phenolic resole.

U.S. Pat. No. 4,500,692 relates to suspension polymerization of a vinyl aromatic monomer in the presence of an inorganic phosphate suspension system and sodium polystyrenesulfonate. The possibility of copolymerization of the vinyl aromatic monomer with a co-monomer is briefly mentioned. Butadiene is included in a list of possible co-monomers.

U.S. Pat. No. 5,051,461 relates to an emulsion of metal neutralized sulfonated copolymer of a conjugated diene and an ethoxylated alkylamine salt of styrene sulfonate, and a tackifier resin. U.S. Pat. No. 4,530,987 relates to a polymer of at least 80% by weight of a conjugated diene and a minor proportion of a metal or amine neutralized styrene sulfonate monomer.

U.S. Pat. Nos. 5,200,459; 5,300,555; and 5,496,884 disclose emulsion polymerization of dichlorobutadiene monomers in the presence of polyvinyl alcohol and a co-solvent such as an organic alcohol or a glycol. Polyvinyl alcohol-stabilized dichlorobutadiene latex has been successfully commercialized, but it has a few drawbacks. Namely, PVA stabilized diclorobutadiene latex was generally thought to be incompatible with phenolic resins.

Commonly assigned U.S. Pat. No. 6,723,778 entitled “Butadiene polymer latex”, attempts to overcome the above-mentioned problem by providing an aqueous adhesive composition comprising a phenolic resin and an aqueous butadiene polymer latex prepared by emulsion polymerization of at least one butadiene monomer in the presence of a stabilizer such as styrene sulfonic acid, styrene sulfonate, poly(styrene sulfonic acid) or poly (styrene sulfonate) and an anionic surfactant, and is hereby incorporated by reference in full.

In particular, the use of a volatile organic co-solvent requires its removal from the emulsion latex prior to adhesive formulation. If not all the co-solvent is removed, the resulting adhesive may have an unacceptably high amount of volatile organic compounds (VOC). In addition, a high concentration of surfactants is used in the emulsion polymerization. High concentration of surfactants in adhesive compositions may cause the well-known “surfactant penalty” problem in the performance of the adhesive. The latex also suffers from compatibility problems when mixed with a water soluble phenolic resin or an aqueous dispersion or emulsion of a phenolic resin. It is therefore important to provide an adhesive comprising a latex which is compatible with the phenolic resin and overcomes the disadvantages of the prior art while providing good adhesion.

Heretofore it has been understood that rubber to substrate adhesives rely on a cross linking agent in the covercoat such as dinitrosobenzene (DNB). However, DNB is difficult to manufacture due to the explosive nature of one of its precursors. Additionally, the presence of DNB in the adhesive causes problems, such as mold fouling or rubber procuring, when parts are subjected to a prebake or otherwise heated prior to bonding. It would therefore further be advantageous to provide a rubber to substrate adhesive which does not rely on a cross linker in the outer adhesive layer.

### SUMMARY OF THE INVENTION

According to an embodiment of the present invention, there is provided an aqueous adhesive composition that includes (A) a butadiene polymer latex that is prepared by an emulsion polymerization in the presence of a polyvinyl alcohol stabilizer and (B) a phenolic resin.

An important advantage of the adhesives of the present invention is the compatibility of the butadiene polymer latex with phenolic resins. The butadiene polymer is emulsion polymerized in the presence of a polyvinyl alcohol stabilizer to form the latex. This stabilization system is particularly effective for a butadiene polymer that is derived from at least 60 weight percent dichlorobutadiene monomer, based on the amount of total monomers used to form the butadiene polymer.

The butadiene polymer latex of the invention is particularly useful in liquid adhesives or primers, especially adhesives or primers for bonding a polymeric surface to a metallic surface. Another advantage of the present invention is a rubber to metal adhesive which does not require a curative such as dinitrosobenzene or a methylene donor such as gamma-POM to aid in adhesion.

A further advantage of the present invention provides a rubber to metal adhesive that cures at roughly the same time as the rubber. In one embodiment the adhesive coated part is baked in an oven to enhance the adhesion characteristics. While most adhesives used in rubber bonding applications are not tolerant to heat cycles at this high of temperature and durations, the adhesive of the present invention shows excellent adhesion after baking parts for 10-15 minutes at 400 F prior to the molding/curing cycle of the rubber.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

### DETAILED DESCRIPTION

Unless otherwise indicated, description of components in chemical nomenclature refers to the components at the time of addition to any combination specified in the description, but does not necessarily preclude chemical interactions among the components of a mixture once mixed.

Certain terms used in this document are defined below.

“Butadiene polymer” means a polymer prepared from butadiene monomers alone or from a combination of butadiene monomers and other copolymerizable monomers described in more detail below. “Butadiene polymer,” therefore, refers to butadiene homopolymer, butadiene copolymer, butadiene terpolymer, and higher polymers. “Phenolic compound” means a compound that includes at least one hydroxy functional group attached to a carbon atom of an aromatic ring. Illustrative phenolic compounds include unsubstituted phenol per se, substituted phenols such as alkylated phenols and multi-hydroxy phenols, and hydroxy-substituted multi-ring aromatics. Illustrative alkylated phenols include methylphenol (also known as cresol), dimethylphenol (also known as xylenol), 2-ethylphenol, pentylphenol and tert-butyl phenol. “Multi-hydroxy phenolic compound” means a compound that includes more than one hydroxy group on each aromatic ring. Illustrative multi-hydroxy phenols include 1,3-benzenediol (also known as resorcinol), 1,2-benzenediol (also known as pyrocatechol), 1,4-benzenediol (also known as hydroquinone), 1,2,3-benzenetriol (also known as pyrogallol), 1,3,5-benzenetriol and 4-tert-butyl-1,2-benzenediol (also known as tert-butyl catechol). Illustrative hydroxy-substituted multi-ring aromatics include 4,4′isopropylidenebisphenol (also known as bisphenol A), 4,4′methylidenebisphenol (also known as bisphenol F) and naphthol.

“Aldehyde compound” means a compound having the generic formula RCHO. Illustrative aldehyde compounds include formaldehyde, acetaldehyde, propionaldehyde, n-butylaldehyde, n-valeraldehyde, caproaldehyde, heptaldehyde and other straight-chain aldehydes having up to 8 carbon atoms, as well as compounds that decompose to formaldehyde such as paraformaldehyde, trioxane, furfural, hexamethylenetriamine, acetals that liberate formaldehyde on heating, and benzaldehyde.

“Phenolic resin” generally means the reaction product of a phenolic compound with an aldehyde compound.

In a first embodiment of the present invention, the butadiene monomers useful for preparing a butadiene polymer latex comprise any monomer containing conjugated unsaturation. Typical monomers include 2,3-dichloro-1,3-butadiene; 1,3-butadiene; 2,3-dibromo-1,3-butadiene isoprene; isoprene; 2,3-dimethylbutadiene; chloroprene; bromoprene; 2,3-dibromo-1,3-butadiene; 1,1,2-trichlorobutadiene; cyanoprene; hexachlorobutadiene; and combinations thereof. It is particularly preferred to use 2,3-dichloro-1,3-butadiene since a polymer that contains as its major portion 2,3-dichloro-1,3-butadiene monomer units has been found to be particularly useful in adhesive applications due to the excellent bonding ability and barrier properties of the 2,3-dichloro-1,3-butadiene-based polymers. As described above, an especially preferred embodiment of the present invention is one wherein the butadiene polymer includes at least 60 weight percent, preferably at least 70 weight percent, 2,3-dichloro-1,3-butadiene monomer units.

In a further embodiment of the present invention, the butadiene monomer is copolymerized with other monomers. Representative copolymerizable monomers include α-haloacrylonitriles such as α-bromoacrylonitrile and α-chloroacrylonitrile; α,β-unsaturated carboxylic acids such as acrylic, methacrylic, 2-ethylacrylic, 2-propylacrylic, 2-butylacrylic and itaconic acids; alkyl-2-haloacrylates such as ethyl-2-chloroacrylate and ethyl-2-bromoacrylate; α-bromovinylketone; vinylidene chloride; vinyl toluenes; vinylnaphthalenes; vinyl ethers, esters and ketones such as methyl vinyl ether, vinyl acetate and methyl vinyl ketone; esters amides, and nitriles of acrylic and methacrylic acids such as ethyl acrylate, methyl methacrylate, glycidyl acrylate, methacrylamide and acrylonitrile; and combinations of such monomers.

In a preferred embodiment of the present invention, the copolymerizable monomers, comprise α-haloacrylonitrile and/or α,β-unsaturated carboxylic acids. The copolymerizable monomers may be utilized in an amount of 0.1 to 40 weight percent, based on the weight of the total monomers utilized to form the butadiene polymer.

The butadiene homopolymer or copolymer is emulsion polymerized in the presence of a polyvinyl alcohol stabilizer. The polyvinyl alcohol (PVA) of the present invention can be any PVA, commercially or otherwise available, which will dissolve in the present aqueous polymerization system at the temperature of the polymerization. Such PVA will usually be the product of hydrolysis of polyvinyl acetate, wherein the degree of hydrolysis is preferably about 80-99 percent. The average degree of polymerization of the PVA will be about 350-2,500. For a general discussion of various PVAs, see The Encyclopedia of Polymer Science and Technology, Interscience Publishers, Vol. 14, pp. 149ff, (1971). The preferred proportion of PVA is about 3 to 12, preferably about 6 to 8, parts per 100 parts by weight of total monomers. The PVA acts as an emulsion stabilizer during the polymerization.

In carrying out the emulsion polymerization to produce the latex other optional ingredients may be employed during the polymerization process. For example, conventional anionic and/or nonionic surfactants may be utilized in order to aid in the formation of the latex. Typical anionic surfactants include carboxylates such as fatty acid soaps from lauric, stearic, and oleic acid; acyl derivatives of sarcosine such as methyl glycine; sulfates such as sodium lauryl sulfate; sulfated natural oils and esters such as Turkey Red Oil; alkyl aryl polyether sulfates; alkali alkyl sulfates; ethoxylated aryl sulfonic acid salts; alkyl aryl polyether sulfonates; isopropyl naphthalene sulfonates; sulfosuccinates; phosphate esters such as short chain fatty alcohol partial esters of complex phosphates; and orthophosphate esters of polyethoxylated fatty alcohols. Typical nonionic surfactants include ethoxylated (ethylene oxide) derivatives such as ethoxylated alkyl aryl derivatives; mono-and polyhydric alcohols; ethylene oxide/propylene oxide block copolymers; esters such as glyceryl monostearate; products of the dehydration of sorbitol such as sorbitan monostearate and polyethylene oxide sorbitan monolaurate; amines; lauric acid; and isopropenyl halide. A conventional surfactant, if utilized, is employed in an amount of 0.01 to 5 parts, preferably 0.1 to 2 parts, per 100 parts by weight of total monomers utilized to form the butadiene polymer.

In the case of dichlorobutadiene homopolymers, anionic surfactants are particularly useful. Such anionic surfactants include alkyl sulfonates and alkyl aryl sulfonates and sulfonic acids or salts of alkylated diphenyl oxide for example, didodecyl diphenyleneoxide disulfonate or dihexyl diphenyloxide disulfonate.

Chain transfer agents may also be employed during emulsion polymerization in order to control the molecular weight of the butadiene polymer and to modify the physical properties of the resultant polymer as is known in the art. Any of the conventional organic sulfur-containing chain transfer agents may be utilized such as alkyl mercaptans and dialkyl xanthogen disulfides.

The formation of the latex is carried out by emulsion polymerizing the appropriate monomers in the presence of the PVA stabilizer and the optional ingredients. Specifically, an aqueous emulsification mixture of water and the PVA is formed to which is added the appropriate monomers. The emulsification mixture preferably contains 40 to 80, more preferably 50 to 70, weight percent water.

The emulsion polymerization is typically triggered by a free radical initiator. Illustrative free radical initiators include conventional redox systems, peroxide systems, azo derivatives and hydroperoxide systems. The use of a redox system is preferred and examples of such systems include ammonium persulfate/sodium metabisulfite, ferric sulfate/ascorbic acid/hydroperoxide and tributylborane/hydroperoxide, with ammonium persulfate/sodium metabisulfite being most preferred.

The emulsion polymerization is typically carried out at a temperature of 10° C.-90° C., preferably 40° C.-60° C. Monomer conversion usually ranges from 70-100, preferably 80-100, percent. The latices preferably have a solids content of 10 to 70, more preferably 30 to 60, percent; a viscosity between 50 and 10,000 centipoise at 25° C.; and a particle size between 60 and 300 nanometers.

The latices of the present invention exhibit both superior mechanical stability and electrolytic stability. Mechanical stability means that the latex does not irreversibly phase disperse or irreversibly form a precipitate or coagulant over an extended period of time. It is expected that latices according to the invention should remain mechanically stable (in other words, have a shelf life) for at least 12 months. Electrolytic stability means that the latices are very resistant to changes in ionic strength. This characteristic is important when the latices are formulated with other ionic components, particularly salts, to create a multi-component composition such as an adhesive.

As described above, one embodiment of the present invention is a composition that includes the PVA-stabilized butadiene latex and a phenolic resin and is especially useful to bond elastomeric surfaces to metallic surfaces. The phenolic resin can be any waterborne-type that is compatible with the PVA-stabilized butadiene latex. Illustrative phenolic resins include water soluble phenolic resins and an aqueous phenolic resin dispersions.

In one embodiment of the present invention, the phenolic resin comprises a resole, a novolak or a mixture thereof. However, in a preferred embodiment of the present invention, the phenolic resin comprises a resole. The phenolic resole is an aqueous dispersible or soluble heat-reactive condensation product of an aldehyde compound with a phenolic compound. The resoles are well-known and are typically prepared by reacting a phenolic compound with an excess of an aldehyde compound in the presence of a base catalyst. Illustrative waterborne phenolics include polyvinyl alcohol-stabilized aqueous resole dispersions; an aqueous dispersion of a heat-reactive hydrophilic phenolic resin, a hydrophobic etherified bisphenol-A resin and a protective colloid; water-soluble sulfonated phenolic resins; aqueous novolak resins; aqueous solutions of lower condensate of phenolic resins; aqueous solutions of phenolic resins containing concentrated caustic acid; aqueous emulsions of phenolic resins that include polyacrylamide; and aqueous novolak dispersions.

In a preferred embodiment of the present invention, the phenolic resin comprises a polyvinyl alcohol-stabilized aqueous dispersion of a resole. This dispersion can be prepared by a process that includes mixing the pre-formed, solid, substantially water-insoluble, phenolic resole resin; water; an organic coupling solvent; and polyvinyl alcohol, at a temperature and for a period of time sufficient to form a dispersion of the phenolic resole resin in water. Such polyvinyl alcohol-stabilized aqueous resole dispersions are produced by reacting formaldehyde with bisphenol-A in a mol ratio of 2 to 3.75 moles of formaldehyde per mole of bisphenol-A in the presence of a catalytic amount of an alkali metal or barium oxide or hydroxide condensation catalyst wherein the reaction is carried out at elevated temperatures. The condensation product is then neutralized to a pH of 3 to 8. Alcohols, glycol ethers, ethers, esters and ketones are the most useful coupling solvents. Specific examples of useful coupling solvents include ethanol, n-propanol, isopropyl alcohol, ethylene glycol monobutyl ether, ethylene glycol monoisobutyl ether, ethylene glycol monomethyl ether acetate, diethylene glycol monobutyl ether, diethylene glycol monoethyl ether acetate, propylene glycol monopropyl ether, methoxy acetone, and the like. The polyvinyl alcohol is typically prepared by hydrolysis of polyvinyl acetate. The most useful polyvinyl alcohol polymers are hydrolyzed to an extent of 85 to 91 percent and have molecular weights such that a 4 percent solids solution of the polyvinyl alcohol in water has a viscosity of 4 to 25 centipoises at 25° C. The addition of a PVA stabilized phenolic resin to a PVA stabilized diclorobutadiene latex does not exhibit the compatibility issues seen in the prior art between PVA stabilized latex and phenolic resins.

The amount of the phenolic resin can range broadly depending upon the particular use of the composition. In general, the phenolic resin can be present in an amount of 5 to 90, preferably 10 to 40, weight percent, based on the total amount of butadiene latex and phenolic resin.

In another embodiment of the present invention, the aqueous adhesive compositions optionally comprise well known additives such as a metal oxide (for example, zinc oxide, lead oxide and zirconium oxide), lead-containing compounds (for example, polybasic lead salts of phosphorous acid and saturated and unsaturated organic dicarboxylic acids and anhydrides), plasticizers, fillers, pigments, surfactants, dispersing agents, wetting agents, reinforcing agents and the like, in amounts employed by those skilled in the adhesive arts. Examples of optional ingredients include carbon black, silica such as fumed silica, sodium aluminosilicate and titanium dioxide.

Water, preferably deionized water, is utilized in combination with the butadiene latex and the phenolic resin and any optional components of the invention in order to provide an adhesive or primer composition having any desired final solids content.

The adhesive or primer composition may be applied to a surface or substrate for bonding by spraying, dipping, brushing, wiping, roll-coating (including reverse roll-coating) or the like, after which the adhesive composition is permitted to dry. The composition typically is applied in an amount sufficient to form a dry film.

The adhesive or primer composition can be used to bond any types of substrates or surfaces together, but it is particularly useful to bond a metal substrate or surface to a polymeric material substrate or surface. The polymeric material can be any elastomeric material selected from any of the natural rubbers and olefinic synthetic rubbers including polychloroprene, polybutadiene, neoprene, styrene-butadiene copolymer rubber, acrylonitrile-butadiene copolymer rubber, ethylene-propylene copolymer rubber (EPM), ethylene-propylene-diene terpolymer rubber (EPDM), butyl rubber, brominated butyl rubber, alkylated chlorosulfonated polyethylene and the like. The metal substrate may be selected from any of the common structural metals such as iron, steel (including stainless steel and electrogalvanized steel), lead, aluminum, copper, brass, bronze, MONEL® metal alloy, nickel, zinc and the like. Prior to bonding, the metal surface is typically cleaned according to one or more methods known in the art such as degreasing, grit-blasting and zinc-phosphatizing.

The adhesive or primer composition usually is applied to the metal and/or polymeric surface and the substrate surfaces are then brought together under heat and pressure to complete the bonding procedure. The exact conditions selected will depend upon the particular polymer being bonded and whether or not it is cured. In some cases, it may be desirable to preheat the metal surface prior to application of the adhesive composition to assist in drying of the adhesive composition. The coated surface of the metal and the polymeric substrate are typically brought together under a pressure of from 20 to 175 MPa, preferably from 20 to 50 MPa. If the polymer is uncured, the resulting polymer-metal assembly is simultaneously heated to a temperature of from 140° C. to 200° C., preferably from 150° C. to 170° C. The assembly should remain under the applied pressure and temperature for a period of 3 minutes to 60 minutes, depending on the cure rate and thickness of the polymeric substrate. If the polymer is already cured, the bonding temperature may range from 90° C. to above 180° C. for 15 to 120 minutes.

The bonding process may be carried out by applying the polymeric substrate as a semi-molten material to the metal surface as in, for example, an injection-molding process. The process may also be carried out by utilizing compression molding, transfer molding or autoclave curing techniques. After the process is complete, the bond is fully vulcanized and ready for use in a final application.

### EXAMPLES

### Preparation of Polyvinyl Alcohol-Stabilized Latex;

A polyvinyl alcohol-stabilized dichlorobutadiene/α-bromoacrylonitrile copolymer latex is prepared with the following ingredients (PHM=parts per hundred parts monomer):

| Ingredient | Weight (g) | PHM |
|---|---|---|
| 2,3-dichloro-1,3-butadiene | 656.0 | 82.0 |
| (90% in CH₂Cl₂) | | |
| α-bromoacrylonitrile | 144.0 | 18.0 |
| Polyvinyl alcohol | 56.0 | 7.0 |
| Deionized water | 1056.0 | 132.0 |
| Methanol | 400.0 | 50.0 |
| (NH₄)₂S₂O₈ | 4.0 | 0.5 |
| Na₂S₂O₅ | 4.0 | 0.5 |

The polyvinyl alcohol, methanol, Na₂S₂O₅ and 856 grams of water are added to a 3 L flask equipped with stirring, N₂, heat and a condenser. The mixture is heated to 50° C., after which the two monomers and the (NH₄)₂S₂O₈ dissolved in the remaining water are added over a 1 hour period. The resulting latex was vacuumed-stripped for 1 hour at 80 mmHg and 50° C. to remove the methanol. The latex has a solids content of 42.8% and a viscosity of 300 centipoise.

### Preparation of Adhesive Composition:

| Ingredient | Dry Weight % |
|---|---|
| Phenolic resole dispersion in water^{(a)} | 30 |
| DCD/alpha-bran latex | 70 |

^{(a)}Georgia Pacific BKUA 2370

The adhesive is prepared using the above formulation according to the following steps:
Step #1 Adjust the pH of the latex to approximately 7 with ammonium hydroxide.
Step #2. Add the proper amount of the resole to a container.
Step #3. Add the latex to the resole and stir.
Step #4. Add water to lower the solids to 30% TSC and mix thoroughly.

This formulation was then spray applied over a primed zinc-phosphatized coupon at a dry film thickness of approximately 0.6 mils and baked for 10 minutes at 400° F. The primer/covercoat adhesive was then ready for the bonding process. Once the water had left the adhesive film and the adhesive layers were dry, the coated substrate was taken to a rubber molding operation and placed in a mold where rubber was introduced and vulcanized.

The following tests were performed and 100R indicates 100% rubber tearing bonds or 100% rubber retention on the metal coupon.

### Test 1

Adhesives: Primer A (aqueous DCD/Alpha BRAN latex with DNB)

Covercoats—Covercoat A
70% 95/5 DCD ALPHA BRAN
30% GPRI 4001 (PVA stabilizes phenolic resole from Georgia Pacific)

Covercoat B
70% 95/5 DCD ALPHA BRAN
30% BKUA 2370 (PVA stabilizes phenolic resole from Georgia Pacific)
Rubber: NR cure 12 minutes @ 350° F. Compression molded
Testing: HOT TEAR (PULL APART BY HAND AS SOON AS THE PARTS COME OUT OF THE PRESS)
Bake cycles: NO BAKE
   10 MINUTES AT 300° F.
   10 MINUTES AT 325° F.
   10 MINUTES AT 350° F.
   10 MINUTES AT 375° F.
   10 MINUTES AT 400° F.
Results:

| | Primer A/Covercoat A | Primer A/Covercoat B |
|---|---|---|
| NO BAKE | 1% Rubber | 100% Failure |
| | 99% Failure | |
| 10 MINUTES @ 300° F. | 8% Rubber | 3% Rubber |
| | 92% Failure | 97% Failure |
| 10 MINUTES @ 325° F. | 5% Rubber | 5% Rubber |
| | 95% Failure | 95% Failure |
| 10 MINUTES @ 350° F. | 5% Rubber | 10% Rubber |
| | 95% Failure | 90% Failure |
| 10 MINUTES @ 375° F. | 99% Rubber | 99% Rubber |
| | 1% Failure | 1% Failure |
| 10 MINUTES @ 400° F. | 100% Rubber | 100% Rubber |

Conclusion: Bake cycles of at least 10 minutes at 375° F. and 400° F. provide excellent Hot Tear resistance.

### Test 2

Rubber: Natural Rubber A cured at 340° F.
   Natural Rubber B cured at 340° F.
Testing: Hot Tear and Boiling Water
   Hot Tear is tested by hand peeling the rubber immediately out of the mold.
   Boiling water is tested for 24 hours with a 2 Kg weight at approx 130 degree angle, after exposure/immersion parts were tested on a UTS three stage tester at a 45 degree angle with a crosshead speed of 20 inches per minute.
Results:

| | | | NR A | NR B | NR B |
|---|---|---|---|---|---|
| | DFT OF | NR A | 24 HR | Hot | 24 HR |
| | Covercoat A | Hot Tear | BW | Tear | BW |
| MJ/Covercoat A | 0.2 mils | 100% | No Data | 100% | No Data |
| No bake | | Failure | | Failure | |
| MJ/Covercoat A | 0.2 mils | 100% | 100% | 100% | 100% |
| Bake | | Rubber | Rubber | Rubber | Rubber |
| MJ/Covercoat A | 0.4 mils | 100% | No Data | 100% | No Data |
| No bake | | Failure | | Failure | |
| MJ/Covercoat A | 0.4 mils | 100% | 100% | 100% | 100% |
| Bake | | Rubber | Rubber | Rubber | Rubber |

MJ is the MetalJacket ® 1100/2110 metal treatment system commercially available from LORD Corporation. The MJ1100/MJ2110 system is autodeposited over cold rolled steel coupons, then B-staged at 350° F. for 20 minutes prior to application of Covercoat A.

Conclusion: When baked the Covercoat A provided excellent results in all tests when applied over MetalJacket 1100/2110 system.

### Test 3

Adhesives: A. 100% DCD/Alpha Bran (95/5) dry weight
   B. 90% DCD/ Alpha Bran (95/5) & 10% GPRI 4001 dry weight
   C. 80% DCD/ Alpha Bran (95/5) & 20% GPRI 4001 dry weight
   D. 70% DCD/ Alpha Bran (95/5) & 30% GPRI 4001 dry weight
   E. 60% DCD/ Alpha Bran (95/5) & 40% GPRI 4001 dry weight
   F. 50% DCD/ Alpha Bran (95/5) & 50% GPRI 4001 dry weight
Substrate: MJ prepared coupons that were B-staged prior to adhesive application. MJ1100/MJ2110 applied at 1.2-1.4 mils DFT.
Dft: The covercoats adhesives will be applied via spray over the MJ b-staged coupons at 0.6-0.8 mils
Bake: The now adhesive coated parts are baked 15 minutes at 400° F. and allowed to return to room temperature prior to bonding.
Rubber and Testing: NR cured at 320° F., 0 and 5 minute prebake Boiling water 24 hours with 2 kg hanging weight also pulled hot right out of the mold.
   NR cured at 340° F., 0 and 5 minute prebake Boiling water 24 hours with 2 kg hanging weight also pulled hot right out of the mold.
   NR cured at 360° F., 0 and 5 minute prebake Boiling water 24 hours with 2 kg hanging weight also pulled hot right out of the mold.
Results:

### NR CURED AT 320° F.

| | 0 minute prebake | 5 minute prebake | 0 minute prebake |
|---|---|---|---|
| | 24 HOURS BW | 24 HOURS BW | HOT TEAR |
| ADH A | 100R | 100R | 10R |
| ADH B | 100R | 100R | 30R |
| ADH C | 100R | 100R | 80R |
| ADH D | 100R | 100R | 83R |
| ADH E | 50R | 100R | 2R |
| ADH F | 0R | 100R | 0R |

### NR CURED AT 340° F.

| | 0 minute | | |
|---|---|---|---|
| | prebake | 5 minute prebake | 0 minute prebake |
| | 24 HOURS BW | 24 HOURS BW | HOT TEAR |
| ADH A | 100R | 100R | 88R |
| ADH B | 100R | 100R | 100R |
| ADH C | 100R | 100R | 100R |
| ADH D | 100R | 100R | 100R |
| ADH E | 100R | 100R | 100R |
| ADH F | 100R | 100R | 100R |

### NR CURED AT 360° F.

| | 0 minute prebake | 5 minute prebake | 0 minute prebake |
|---|---|---|---|
| | 24 HOURS BW | 24 HOURS BW | HOT TEAR |
| ADH A | 100R | 100R | 58 |
| ADH B | 100R | 100R | 100R |
| ADH C | 100R | 100R | 100R |
| ADH D | 100R | 100R | 100R |
| ADH E | 100R | 100R | 100R |
| ADH F | 100R | 100R | 100R |

Conclusion: When you bake or B-stage the covercoat adhesive for 15 minutes at 400F the performance is excellent over MJ primed metals.

### Test 4

Substrate: MetalJacket coated coupons. MJ1100/MJ2110 applied 1.2-1.4 mils DFT and then B-stage 15 minutes at 350° F. prior to the covercoat application.
Adhesive: SYSTEM A (prior art)
   Primer—novolak resin/gamma-pom/flexibilizer
   Covercoat—DNB/DCDalpha-bran latex

SYSTEM B (prior art)
Primer—polychloroprene/phenolic resin/metal oxide
Covercoat—chlorosulfonated polyethylene/DNB/lead/bismaleimide

SYSTEM C. (embodiment of present invention)
Primer—MJ 1100/2110 system
Covercoat—Covercoat A
Rubber: Natural Rubber A CURED AT 340° F. and 360° F.
   Natural Rubber B CURED AT 340° F. and 360° F.
Prebakes tested: 0, 3, 6, 9, 12, and 15 minutes at the cure temperature of the rubber
Test: RT PULLS at a 45 degree angle at a crosshead speed of 20 inches per minute
Results:

| | Natural Rubber A | | | Natural Rubber A | | |
|---|---|---|---|---|---|---|
| | at 340° F. | | | at 360° F. | | |
| | Adh.A | Adh.B | Adh.C | Adh.A | Adh.B | Adh.C |
| 0 minutes | 82#100R | 67#100R | 48#100R | 72#100R | 56#100R | 49#100R |
| 3 minutes | 78#100R | 61#100R | 47#100R | 59#100R | 48#100R | 46#100R |
| 6 minutes | 69#100R | 57#100R | 47#100R | HP 0R | HP 0R | 51#100R |
| 9 minutes | HP 0R | HP 0R | 52#100R | HP 0R | HP 0R | 51#100R |
| 12 minutes | HP 0R | HP 0R | 49#100R | HP 0R | HP 0R | 47#100R |
| 15 minutes | HP 0R | HP 0R | 51#100R | HP 0R | HP 0R | 45#100R |

(HP = hand peel)

| | Natural Rubber B | | | Natural Rubber B | | |
|---|---|---|---|---|---|---|
| | at 340° F. | | | at 360° F. | | |
| | Adh.A | Adh.B | Adh.C | Adh.A | Adh.B | Adh.C |
| 0 minutes | 37#100R | 38#100R | 35#100R | 29#100R | 28#100R | 30#100R |
| 3 minutes | 39#100R | 40#100R | 32#100R | 29#100R | 33#100R | 28#100R |
| 6 minutes | 40#100R | 38#100R | 35#100R | 21#100R | HP 0R | 30#100R |
| 9 minutes | HP 0R | HP 0R | 33#100R | HP 0R | HP 0R | 30#100R |
| 12 minutes | HP 0R | HP 0R | 34#100R | HP 0R | HP 0R | 27#100R |
| 15 minutes | HP 0R | HP 0R | 36#100R | HP 0R | HP 0R | 25#100R |

(HP = hand peel)

Conclusion: The new aqueous covercoat “C” in the above table has some of the best prebake ever observed and clearly outperforms both commercially available adhesives.

### Test 5

### 75/25 (95/5 DCD A-BRAN TO GPRI 4001) APPLIED OVER MJ/CRS

| | CURE at | | CURE at | | CURE at | |
|---|---|---|---|---|---|---|
| | 320° F. HT | | 340° F. HT | | 360° F. HT | |
| | Unbaked | Baked | Unbaked | Baked | Unbaked | Baked |
| Natural | Failed | ? | Failed | Failed | Failed | ? |
| Rubber | | | | | | |
| A | | | | | | |
| Natural | Failed | ? | Failed | Passed | Failed | ? |
| Rubber | | | | | | |
| B | | | | | | |
| Natural | Failed | Passed? | Failed | Passed | Failed | Passed |
| Rubber | | | | | | |
| C | | | | | | |
| Natural | Failed | Failed | Failed | Passed | Failed | Passed |
| Rubber | | | | | | |
| D | | | | | | |
| Natural | Failed | Passed | Failed | Passed | Failed | Passed |
| Rubber | | | | | | |
| E | | | | | | |
| Natural | Failed | Failed | Failed | Passed | Failed | Passed |
| Rubber | | | | | | |
| F | | | | | | |
| Natural | Failed | Passed | Failed | Passed | Failed | Passed |
| Rubber | | | | | | |
| G | | | | | | |
| Natural | Failed | Failed | Failed | Passed | Failed | Passed |
| Rubber | | | | | | |
| H | | | | | | |

### 75/25 (95/5 DCD A-BRAN TO GPRI 4001) APPLIED OVER E1001110/ZPS

| | CURE at | | CURE at | | CURE at | |
|---|---|---|---|---|---|---|
| | 320° F. HT | | 340° F. HT | | 360° F. HT | |
| | Unbaked | Baked | Unbaked | Baked | Unbaked | Baked |
| Natural | | | Failed | Failed | | |
| Rubber | | | | | | |
| A | | | | | | |
| Natural | | | Failed | Passed | | |
| Rubber | | | | | | |
| B | | | | | | |
| Natural | Failed | Passed? | Failed | Passed | Failed | Failed? |
| Rubber | | | | | | |
| C | | | | | | |
| Natural | Failed | Failed | Failed | Passed | Failed | Passed |
| Rubber | | | | | | |
| D | | | | | | |
| Natural | Failed | Passed | Failed | Passed | Failed | Passed |
| Rubber | | | | | | |
| E | | | | | | |
| Natural | Failed | Failed | Failed | Passed | Failed | Passed |
| Rubber | | | | | | |
| F | | | | | | |
| Natural | Failed | Passed | Failed | Passed | Failed | Passed |
| Rubber | | | | | | |
| G | | | | | | |
| Natural | Failed | Failed | Failed | Passed | Failed | Passed |
| Rubber | | | | | | |
| H | | | | | | |

### 75/25 (95/5 DCD A-BRAN TO GPRI 4001) APPLIED OVER MJ/CRS

| | CURE at | | CURE at | | CURE at | |
|---|---|---|---|---|---|---|
| | 320° F. 24 HR | | 340° F. 24 HR | | 360° F. 24 HR | |
| | BW | | BW | | BW | |
| | Unbaked | Baked | Unbaked | Baked | Unbaked | Baked |
| Natural | | | Failed | 100R | | |
| Rubber | | | | | | |
| A | | | | | | |
| Natural | | | Failed | 100R | | |
| Rubber | | | | | | |
| B | | | | | | |
| Natural | Failed | 100R | Failed | 100R | Failed | 50R |
| Rubber | | | | | | |
| C | | | | | | |
| Natural | Failed | 100R | Failed | 100R | Failed | 100R |
| Rubber | | | | | | |
| D | | | | | | |
| Natural | Failed | 100R | Failed | 100R | Failed | 100R |
| Rubber | | | | | | |
| E | | | | | | |
| Natural | Failed | 100R | Failed | 100R | Failed | 50R |
| Rubber | | | | | | |
| F | | | | | | |
| Natural | Failed | 50R | Failed | 5R | Failed | 90R |
| Rubber | | | | | | |
| G | | | | | | |
| Natural | Failed | 50R | Failed | 50R | Failed | 100R |
| Rubber | | | | | | |
| H | | | | | | |

### 75/25 (95/5 DCD A-BRAN TO GPRI 4001) APPLIED OVER E1001110/ZPS

| | CURE at | | CURE at | | CURE at | |
|---|---|---|---|---|---|---|
| | 320° F. 24 HR | | 340° F. 24 HR | | 360° F. 24 HR | |
| | BW | | BW | | BW | |
| | Unbaked | Baked | Unbaked | Baked | Unbaked | Baked |
| Natural | | | 93R | 100R | | |
| Rubber A | | | | | | |
| Natural | | | 0R | 55R(CM)* | | |
| Rubber B | | | | | | |
| Natural | Failed | Failed | Failed | 83R(CM)* | 98R | 99R |
| Rubber C | | | | | | |
| Natural | Failed | 8R | 70R | 68R(CM)* | 99R | 85R(CM)* |
| Rubber D | | | | | | |
| Natural | Failed | 70R(CM)* | 100R | 75R(CM)* | 100R | 100R |
| Rubber E | | | | | | |
| Natural | Failed | Failed | Failed | Failed | 98R | 100R |
| Rubber F | | | | | | |
| Natural | Failed | 25R | Failed | 18R(CM)* | 90R | Failed |
| Rubber G | | | | | | (CM)* |
| Natural | Failed | 50R(CM)* | Failed | 40R(CM)* | 100R | 35R(CM) |
| Rubber H | | | | | | |

*CM failure due to the bake cycle over zinc phosphatized steel.

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

1. An aqueous adhesive composition comprising (a) phenolic resin and (b) an aqueous butadiene polymer latex prepared by emulsion polymerization of at least one butadiene monomer in the presence of a polyvinvyl alcohol.

2. The aqueous adhesive of claim 1, wherein the phenolic resin comprises a polyvinyl alcohol stabilized aqueous dispersion of a phenolic resin.

3. The aqueous adhesive of claim 2, wherein the phenolic resin comprises a resole.

4. The aqueous adhesive of claim 2, wherein the phenolic resin consists essentially of a resole.

5. The aqueous adhesive composition of claim 1, wherein the butadiene monomer is selected from 2,3-dichloro-1 3-butadiene; 1,3-butadiene; 2,3-dibromo-1,3-butadiene; isoprene; 2,3-dimethylbutadiene; chloroprene; bromoprene; 2,3-dibromo-1,3-butadiene; 1,1,2-trichlorobutadiene; cyanoprene; or hexachlorobutadiene.

6. The aqueous adhesive composition of claim 5, wherein the butadiene monomer comprises 2,3-dichloro-1,3-butadiene.

7. The aqueous adhesive composition of claim 1, wherein the butadiene polymer is prepared by copolymerization of the dichlorobutadiene with at least one copolymerizable monomer.

8. The aqueous adhesive composition of claim 7, wherein the copolymerizable monomer comprises an α-haloacrylonitrile.

9. The aqueous adhesive composition of claim 1, wherein the butadiene polymer latex is prepared by emulsion polymerization of at least 60 weight percent dichlorobutadiene monomer.

10. The aqueous adhesive composition of claim 1, wherein the butadiene polymer latex comprises at least 90 weight percent dichlorobutadiene and at least 5 weight percent of an α-haloacrylonitrile, based on the total weight of the monomers.

11. The aqueous adhesive composition of claim 1, wherein the butadiene polymer latex comprises a mixture of (a) a first latex comprising about 95 weight percent dichlorobutadiene and about 5 weight percent of an α-haloacrylonitrile, based on the total weight of the monomers, and (b) a second latex comprising about 82 weight percent dichlorobutadiene and about 18 weight percent of an α-haloacrylonitrile, based on the total weight of the monomers.

12. The aqueous adhesive composition of claim 1, further comprising an anionic surfactant.

13. The aqueous adhesive composition of claim 1, wherein the composition is substantially free of a cross linking agent.

14. The aqueous adhesive of claim 1, wherein the composition is substantially free of dinitrosobenzene.

15. An aqueous adhesive composition consisting essentially of (a) phenolic resin and (b) an aqueous butadiene polymer latex prepared by emulsion polymerization of at least one butadiene monomer in the presence of a polyvinyl alcohol.

16. The aqueous adhesive of claim 17, wherein the phenolic resin comprises a polyvinyl alcohol stabilized aqueous dispersion of a phenolic resole.

17. The aqueous adhesive composition of claim 17, wherein the butadiene monomer comprises 2,3-dichloro-1,3-butadiene.

18. The aqueous adhesive composition of claim 17, wherein the butadiene polymer is prepared by copolymerization of the dichlorobutadiene with at least one copolymerizable monomer.

19. The aqueous adhesive composition of claim 18, wherein the copolymerizable monomer comprises an α-haloacrylonitrile.
